(19) United States
(12) Patent Application Publication
(10) Pub. No.: US 2004/0224279 A1
(43) Pub. Date: Nov. 11, 2004

(54) Dental display system

(75) Inventor: Alexander H. Siemons, Sierra Madre, CA (US)

Correspondence Address: WOOD, HERRON & EVANS, LLP, 2700 CAREW TOWER, 441 VINE STREET, CINCINNATI, OH, 45202, US

(73) Assignee: Ormco Corporation, Orange, CA (US)

(21) Appl. No.: 10/430,550

(22) Filed: May 6, 2003

(51) Int. Cl. A61C 3/00

(52) U.S. Cl. 433/29

(57) ABSTRACT

An attachable display superimposes dental data over a magnified image. The dental data synergistically communicates equipment and patient data to an observer without obstructing visual access to the magnified image.

### FIELD OF THE INVENTION

The present invention relates to dental procedures, and more particularly, to the monitoring of dental equipment and patient conditions in a patient's oral cavity relating to teeth, gums and/or jawbone.

### BACKGROUND OF THE INVENTION

Microscopes have become indispensable within the dental field of practice. Magnification provided by microscopes routinely facilitates procedures relating to oral surgery and other dental applications by enabling superior patient examination. To this end, microscopes commonly mount directly in front of a doctor to provide ready, magnified views of patient teeth and tissues.

The superior views afforded by microscopes, however, can compromise a doctor's awareness of other aspects of a dental procedure. For instance, a doctor looking through an eyepiece of a microscope is blind to important equipment and patient displays. Dental procedures conventionally implicate numerous such displays associated with any number of procedures ranging from root canals and bridgework, to tooth transplants. Economic and practical considerations continue to force doctors to expand their expertise and proficiency to include still other techniques and associated displays.

More particularly, each dental procedure typically requires its own respective battery of supporting equipment. For example, equipment for an oral surgical procedure may include a hand drill coupled to a monitor or other display. The monitor may display a numerical torque readout that must be continuously monitored by a doctor. The same procedure may additionally involve irrigation equipment. The irrigation equipment may have its own display configured to present data relating to flow rate, as well as pump and reservoir status. Another exemplary procedure may involve an apex locator and/or a curing unit. Thus, a doctor must diligently look up from the microscope to monitor each of the different displays.

This action can cause the doctor to constantly interrupt his view of the patient's oral cavity, particularly the tooth undergoing the dental procedure. Such disruption further contributes to doctor fatigue and physical stresses attributable to neck and back contortion. The monitoring of different equipment displays also reduces efficiency and increases risks of patient injury.

Consequently, and for in part the above delineated reasons, there exists a need for an improved manner of monitoring dental equipment displays.

### SUMMARY OF THE INVENTION

The present invention provides an improved apparatus, method and program product for enhancing the efficiency and accuracy of dental procedures by presenting dental data within an observer's view of a magnified image of an oral cavity. For instance, dental data may be superimposed within the eyepiece of a microscope. To this end, a controller may communicate electronically, physically and/or visually with a display that is visually accessible via the eyepiece. The display may overlay a microscope image such that an observer's visual access to a magnified image is not substantially obstructed. Alternatively or additionally, a suitable display may border, frame or otherwise juxtapose the magnified image so that the observer may simultaneously view both the dental data and the image.

A display system that is consistent with the principles of the present invention typically includes one or more dental units coupled to the controller. Exemplary dental units include oral drills, syringes, apex locators, irrigation/air flow regulators, filler dispensers, pulse monitoring equipment and/or conceivably any device having application in a dental procedure. As such, exemplary dental units having particular application within certain embodiments of the present invention may include devices that must be continuously monitored by an observer during a dental procedure. In any case, the connections between the units, controller and microscope may be cable or wireless. Further, the controller may be physically incorporated into either the microscope or the dental unit, and embodiments consistent with the principles of the present invention allow for the display and/or controller to be attached to a conventional microscope.

A display system consistent with the invention may simultaneously communicate information pertinent to the operation of each dental unit to the controller. The controller may process received signals and relay embedded data to the display. One embodiment of the dental system overlays the display within the eyepiece of the microscope. The nature of a display consistent with the principles of the present invention allows an observer to monitor data through the eyepiece without substantially obstructing their view to a magnified object. The display may communicate dental data to the user through a series of superimposed text, graphs, colors, shapes and lights, among other mechanisms. Exemplary dental data includes: apex and temperature readings, torque settings/feedback, equipment status and indicators, as well as hand piece speed and pressure levels.

An observer may customize the display to reflect only those parameters involved in a given procedure. Other parameters may be simultaneously displayed to convey the synergistic relationship present between complementary parameters. For instance, torque and motor speed and file depth readings may provide insight into the comprehensive operation and relative position of a hand drill. Further, dispenser data may be displayed in conjunction with other data from an apex finder to provide an oral surgeon with a more comprehensive perspective. Alternatively, the display may be temporarily disabled to provide the observer with a completely unobstructed view. The system configuration additionally accommodates the recording of still and streamed digital images.

By virtue of the foregoing there is provided an improved microscope display system that addresses shortcomings of prior art systems. These and other objects and advantages of the present invention shall be made apparent in the accompanying drawings and the description thereof.

### BRIEF DESCRIPTION OF THE DRAWINGS

The accompanying drawings, which are incorporated in and constitute a part of this specification, illustrate an embodiment of the invention and, together with a general description of the invention given above, and the detailed description of the embodiment given below, serve to explain the principles of the invention.

FIG. 1 is a block diagram of a dental system in accordance with the principles of the present invention;

FIG. 2 shows a magnified image in accordance with the principles of the present invention and as viewed through a microscope of FIG. 1;

FIG. 3 is a block diagram of a microscope in accordance with the principles of the present invention and having application within the dental system of FIG. 1;

FIG. 4 is a flowchart outlining method steps in accordance with the principles of the present invention and suited for execution within the dental system of FIG. 1; and

FIG. 5 is a flowchart outlining method steps of another embodiment in accordance with the principles of the present invention and also being suited for execution within the dental system of FIG. 1.

### DETAILED DESCRIPTION OF THE PREFERRED EMBODIMENTS

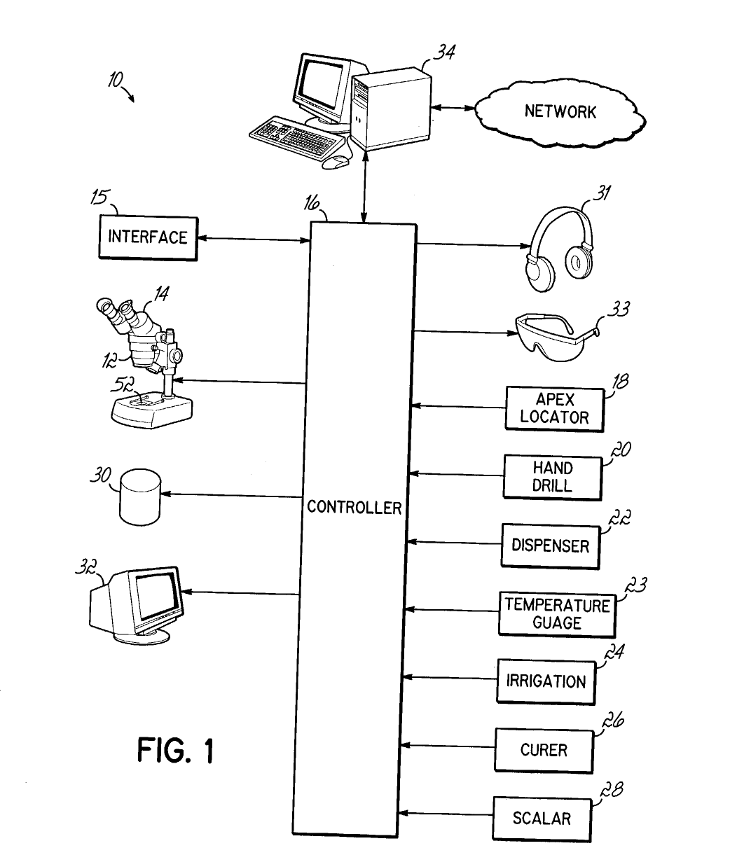

Referring generally to FIG. 1, there is shown a dental system 10 configured to overlay one or more dental parameters within a microscope eyepiece 14. As is known in the art, an exemplary eyepiece 14 may comprise a lens or disk of transparent glass or plastic. The eyepiece 14 may constitute a porthole through which an observer may gaze in order to obtain enhanced surgical views of a dental procedure. The eyepiece 14 typically resides near an end of a magnifying tube of a mono- or a stereoscopic microscope 12. Of note, while stereoscopic microscopes may exhibit particular advantages in certain dental applications that accord with the principles of the present invention, a suitable microscope 12 for purposes of one embodiment may include any number of ocular devices capable of providing a magnified or otherwise augmented view of an image to an observer.

A display that is consistent with the present invention may overlay the magnified image with data pertinent to the dental procedure. In another or the same embodiment, the display may electronically communicate with and/or couple to a controller 16. For instance, the controller 16 may transmit signals to the display. The signals may convey pertinent dental data formatted for presentation to a doctor or other observer via the display. While discussed below in greater detail, an exemplary display may present the data communicated from the controller 16 within or juxtaposing the general field of the microscope image. In one embodiment, the display may overlay the magnified image without substantially obstructing visual access to it. Thus, suitable displays may be substantially superimposed or positioned peripherally in relation to the overall magnified image.

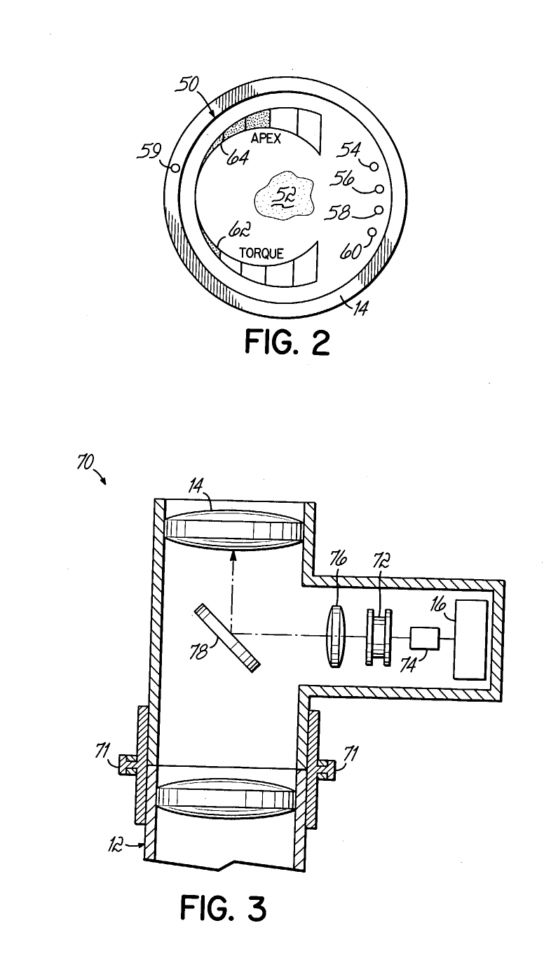

FIG. 2 shows an exemplary magnified image 50 that is consistent with the principles of the present invention as viewed through a microscope eyepiece 14, projection screen or other presentation device.

For purposes of one embodiment of the invention, a suitable image 50 may include all objects 52 visually perceptible to an observer gazing into an eyepiece 14 or other presentation device. The image 50 typically includes a magnified or otherwise augmented perspective of patient tissues and/or a tooth.

Displays 54-64 may be generally indicative of the dental data detected at the respective dental units 18-28. A display 54-64 consistent with the underlying principles of the invention may include components that overlay portions of the image 50. For instance, one display 54-64 in accordance with the principles of the present invention may include organic light emitting diodes (LED's). In another or the same embodiment, a suitable image 50 may be overlaid with a display 54-58, 60-64 that incorporates liquid crystal display (LCD) technologies. LCD's generally include nematic liquid crystals contained within a transparent, conductive medium. When electrified, the crystals transmit and polarize light in such a manner as the structure of the crystals alters to produce desired displays.

Another or the same display 59 consistent with the principles of the present invention may be integral with the microscope eyepiece 14. As such, a suitable display 59 for purposes of this disclosure may be located on the actual eyepiece 14, television/computer monitor 32, or other presentation device supporting the magnified image 50. In this manner, the display 59 may substantially frame, or surround the image 50 without overlaying it. Such hardware may include one or more LED's 59 located around the perimeter of the microscope eyepiece 14 and/or image 50. In one embodiment, LED's 54-58, 60 presented within the image 50 toggle to communicate setting/status information to the user. For instance, a green LED 56 may blink rapidly to indicate that a display is initiating. All LED's 54-60 may blink in unison when a user changes an operating mode of the microscope 12 or other component of the display system 10. An exemplary mode change may enable different display configurations. In another example, a flashing, red LED 54 may indicate a warning condition relating to an undesirable, detected condition.

One skilled in the art should appreciate that exemplary displays 54-64 may include graphs, text, lights, colors, shape variations and numerical readouts, among other display formats. Displays 54-64 may be augmented with audio where desired. The overlaid display 54-64 of one embodiment consistent with the principles of the present invention does not typically obstruct an observer's view of the magnified image 50. Another or the same display system 10, however, may allow an observer to intermittently and selectively view window/data screen displays that present information in a manner that briefly eclipses visual access to the object 52. For instance, a display unit of one embodiment may allow a user to toggle a switch and view an image 50 that consists of a comprehensive chart or other readout of dental data. For instance, exemplary data displayed in this manner may include radiographic information. The user may subsequently toggle back to a completely or only partially unobstructed view of another image 50. Per personal preference, observers may find data presented using such interchangeable image displays to be more desirable.

Thus, the display system 10 may enable an observer to concurrently monitor dental data as they view the object 52 of a surgical or other dental procedure. Significantly, the overlaid display 64 of one embodiment of the invention enables a user to view equipment and patient data without looking away from the microscope eyepiece 14.

While one skilled in the art will appreciate that the processes and hardware of an embodiment of the present invention may transfer into other medical endeavors, monitored “parameters” for purposes of this specification include both variable parameters reflecting the condition of an oral cavity undergoing a dental procedure and variable parameters related to equipment used during a dental procedure. Exemplary oral cavity conditions include the location of a root canal and the relative position of a probe within the root canal, as well as teeth, gums and/or jaw and bone. Examples of equipment related parameters include drill speed and torque, irrigating fluid flow rate and temperature, among others. For that matter, a user for purposes of this specification may include an endodontist, an orthodontist, a dentist, a medical doctor, a technician, a transplant specialist, a surgeon or other specialist desiring the display of pertinent data within their field of vision.

Displayed dental data of an image 50 may be updated continuously and automatically throughout a dental procedure. Those data selections displayed in an image 50 may furthermore be selectable by a user at the onset of and throughout an application. That is, an observer may tailor the display to meet particular application requirements and personal preferences. For instance, a dental application may call for the display of dental data generated by a hand drill 20 and an apex locator 18, but not a scalar 28. As such, the scalar display may be disabled upon initialization of the display system 10.

Such settings may be accomplished via a control pad, toggle switch, microphone or other interface device 15 that is in communication with the controller 16 and may be located near the microscope 12. For instance, the controller 16 may be configured to receive signals from a voice transducer. Such a configuration may allow a user to setup a display using voice recognition software. Other settings may be hardwired or preprogrammed into the controller 16 as per manufacturer specifications or user interface “skins,” such as background color downloaded via the Internet or other network.

While the exemplary controller 16 of FIG. 1 may comprise a sophisticated computer system or network, a suitable controller 16 for purposes of another embodiment that is consistent with the principles of the underlying invention may include any device having electronics configured to receive and transmit signals. One of skill in the art should appreciate that the term, “controller,” for purposes of this specification may furthermore comprise a plurality of separate circuits, each configured to receive and relate data to another controller or one of a plurality of displays.

While either or both the controller 16 and display 54 may be integral with the microscope 12, other embodiments consistent with the invention may position the controller 16 and/or display 54 remotely from the microscope 12. Such a configuration may provide for more work space in the immediate area of the user, or may allow for remote viewing in an instructional setting, for example. Furthermore, the controller 16 may communicate signals to the display 54-64 using wireless connections, such as radio and/or infrared frequency waves, as well laser beams.

Moreover, while a suitable controller 16 may be manufactured integrally with the microscope 12, another controller 16 (and/or display 54-64) in accordance with the principles of the present invention may be configured for attachment to an existing microscope 12. For example, a microscope 12 for purposes of this specification may include an attachable display 54 that slips over and secures to an eyepiece(s) 14 of a conventional microscope. Another embodiment of the present invention may be removably positioned between the eyepiece assembly and the magnifying tube of a conventional microscope. Thus, features of the present invention may enable existing equipment to be economically converted without requiring replacement.

As such, it should be appreciated by one of skill in the art that embodiments of the present invention may accommodate and actually enhance existing microscope and dental hardware systems. Thus, the controller 16, display 54-64 and associated hardware/software may be purchased to update, and not merely supplant, existing systems. Such a feature enables users to enjoy advantages associated with embodiments of the present invention without having to discard prior investment and established preferences.

Where desired, the attachment of the controller 16 to the display 54-64 and/or microscope 12 may be accomplished removably. That is, the controller 16 and/or display 14 may be temporarily secured to the microscope 12. Such a configuration may allow for the removal of the supplemental hardware when not in use. FIG. 3 shows a block diagram of one such microscope 12 suitable for implementation within the dental display system 10 of FIG. 1.

As shown in FIG. 3, a microscope 12 in accordance with the principles of the present invention may include an attachable heads-up display unit 70. In the illustrated embodiment, the exemplary heads-up -display unit 70 comprises a controller 16 configured to receive signals that convey dental data. As discussed herein, the data typically pertains to patient and equipment information. The controller 16, in turn, may reformat or otherwise process the received signals prior to transmitting them to the display and or eyepiece 14. Where the display includes a LCD, the LCD may alter polarized light from a source 74 according to the signals transmitted from the controller 16. For instance, the controller 16 may broker electricity to liquid crystal electrodes to modify the angle of light passing through molecules contained therein. The altered angle may effectively block light passage through corresponding portions of the LCD surface, creating a relatively dark region on the plane of the otherwise transparent LCD surface. Such a relatively dark region may thus comprise a substantially transparent display, in that a user may perceive the phantom image of the display 64 while observing the image 50 of the oral cavity through the display 64.

The surface of the backlit LCD 72 may be focused and projected by a lens 76 onto a beam splitter 78, semi-reflective mirror, or other component positioned so as to deflect or otherwise communicate the backlit image of the LCD 72 to the eyepiece 14. As discussed herein, such an image may include lines, numbers, text, graphs, letters, symbols, etc. that are made visible to a user. Of note, while a LCD 72 may offer some advantages in certain embodiments of the present invention, one of skill in the art should appreciate that LED and laser technologies may be employed alternatively or additionally. Similarly, multiple image beam paths, LCD's, beam splitters, deflecting devices, light sources and/or diffusion screens may additionally be incorporated into embodiments of the present invention to create multiple displays viewable by the observer(s).

Furthermore, while a typical display may attach to the microscope eyepiece 14, another display according with the principles of the present invention may be remotely viewed via a television screen or computer monitor. Moreover, while the heads-up display unit 70 shown in FIG. 3 removably attaches/overlaps onto the eyepiece 14 of the microscope 12 with fasteners 71, another heads-up display unit 70 consistent with the principles of the present invention may alternatively be positioned in between the main objective lens of the microscope 12 and the object 52 being imaged. Thus, the heads-up display unit 70 need not physically attach to the microscope 12. For instance, the heads-up display unit 70 may be supported on a stand or another piece of dental equipment.

Whether detachable or manufactured integrally, the controller 16 may couple to one or more dental units 18-28 as shown in the system 10 of FIG. 1. The dental units 18-28 may include dental modules and other equipment useful in dental applications, including conventional scopes, readouts and other displays. Exemplary units may include an apex locator 18, a surgical drill 20, a filler dispenser 22 and an air/irrigation flow device 24. Still other devices may include a curing unit 26 and a scalar device 28.

The dental units 18-28 shown in FIG. 1 may communicate directly or indirectly with the controller 16. Connections to the controller 16 from the respective units 18-28 may be wireless, such as through the use of radio waves. One of skill in the art should additionally recognize that the dental units 18-28 shown in FIG. 1 are included for exemplary purposes only, and may be substituted with other tools as required for a particular dental application. As such, suitable dental units 18-28 may comprise any piece of equipment having application within a dental environment that is configured to sample or detect a parameter and communicate a signal indicative of the measured parameter. Dental units having application with embodiments of the present invention may further be networked with other devices as desired, and/or may include a controller in direct or indirect communication with the display.

In operation, an observer may utilize one or more of the dental units 18-28 while viewing an object 52 through the microscope eyepiece 14. Dental data detected at each of the respective dental units 18-28 may be communicated to the controller 16. For instance, the apex locator 18 may periodically or continuously transmit a signal to the controller 16. Of note, a suitable controller 16 in one embodiment may be integral with one or more of the dental units 18-28. Such a configuration may, for instance, allow for “peer-to-peer” type communications. Data embedded within the signal may convey a distance or location of a probe relative to the apex of a patient's root canal. Another device 23 may simultaneously transmit a second signal to the controller 16 relating a measured temperature reading.

The controller 16 may convert the format of the arriving signals to one that is compatible with the display. That is, the signals may be formatted such that they initiate an appropriate display within the image 50. As discussed herein, one display that is consistent with the principles of the present invention may overlay the magnified image 50 as viewed by the observer through the microscope eyepiece 14. As such, the controller 16 may initiate a display of the dental data for the user in such a manner as to readily convey the information. To this end, the display may include transparent characteristics to avoid substantial visual obstruction of the object 52.

The controller 16 may update the display of dental data 54-64 as new signals from dental units 18-28 arrive at the controller 16. Thus, the user is made continuously aware of parameters pertaining to the patient, equipment, image 50 and ongoing procedure. According to user or manufacturer preferences, some aspects of a display may appear only upon system 10 initialization, or at the onset of an application. The display of others may automatically initiate in response to detection of a preset condition, to include automatic, sequenced and/or direct user input commands.

In some applications, displayed parameters 54-64 may represent a combination, or product of different dental data. For instance, a green LED 56 flashing at the onset of a procedure may indicate that both an irrigation dispenser and reservoir are in useable condition. Other displayed data may compliment each other to provide a synergistic impression to an observer. For example, the display may include a visual indicator relating to both drill torque and position. Thus, the configurable display may communicate information to sophisticated users in an easily digestible and insightful manner. Displays of other embodiments may be tailored so as to only communicate dental data relating to equipment status, irrespective of patient-related information. Such status data may include detected torque of a drill 20, flow rate of an irrigation system 24, and/or operating status of an apex locator 18.

An image 50, along with its associated display 54-64 of dental data, may be projected onto a monitor 32 or other display mechanism where desired. Such a display feature may allow other users besides the doctor to simultaneously view the procedure in conjunction with the dental data display. Similarly, the image 50 may be downloaded to a computer 34 and/or additional terminals of a computer network. The image 50 may include the dental data, which may aid monitoring and facilitate subsequent evaluation of the procedure. To this end, the display feature of an embodiment of the present invention additionally accommodates recording of procedures on film or digitally within a database 30. Thus, an entire procedure may be stored as correlated to pertinent control and dental data.

It should be noted that suitable displays may comprise any known presentation device fashioned to communicate visual and/or audio data without completely obstructing an observer's view of an object 52. As such, exemplary displays may mount onto glasses 33, visors or other eye wear worn by an observer and configured to present the display. One such pair of glasses 33 may present the display to the observer using laser beam or LCD processes in a manner similar to those discussed herein. A suitable display may be augmented with headphones 31 or other broadcast audio systems configured to sound audio warnings or other cues initiated by the controller 16.

Those skilled in the art will recognize that the exemplary environments illustrated in the accompanying figures are not intended to limit the present invention. Indeed, those skilled in the art will recognize that other alternative hardware and/or software environments may be used without departing from the scope of the invention.

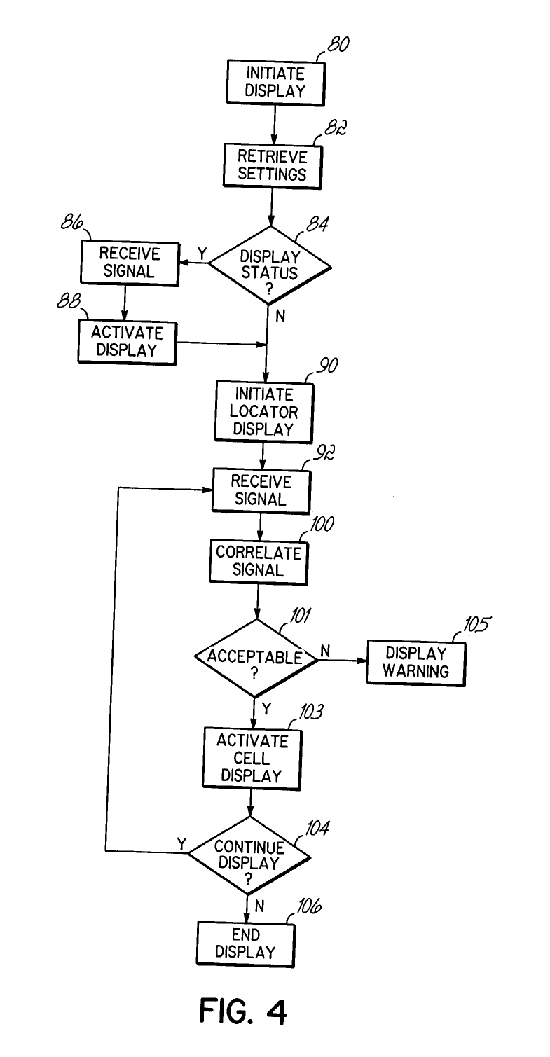

FIG. 4 is a flowchart having sequenced method steps suited for execution within the dental system 10 of FIG. 1. At block 80 of the flowchart, the controller 16 may initiate a light sequence or other display routine intended to convey to a user an operational status of the heads-up display unit 70, microscope 12, patient, and/or dental equipment 18-28. For instance, a LED 56 may flash rapidly in order to communicate to the user that the display is initiating.

The controller 16 may retrieve relevant settings from memory or user input at block 82. Of note, such settings may be preset into the controller 16 and/or be adjustable by the user along any step of the flowchart. Settings may be accomplished via a touch pad, voice recognition software, or another interface 15 configuration available to the user. Settings configurable via the interface 15 may regard the type and sequence of dental data to be displayed within an image 50. For instance, some settings may call for certain dental data to be displayed only in response to a particular condition being realized. One such condition may include detection of a critical pressure reading for a hand tool. For instance, a display may flash in response to the detected torque of a hand drill 20 exceeding a threshold limit.

The controller 16 may initiate a display at block 84 according to the settings retrieved at block 82. That is, the controller 16 may sample the retrieved settings at block 84 to determine if a given dental parameter should be displayed. For instance, the controller 16 may evaluate the settings retrieved at block 82 to determine if the “on” status of an apex locator 18 should be displayed. Where so configured, the controller 16 may receive a signal at block 86 from the apex locator module 18. The signal may convey the operational status of the apex locator module 18. Where the signal indicates full power, the controller 16 may initiate activation of a green LED 56. Of note, while presentation of a green light 54 within the image 50 may suit the display purposes of one embodiment of the present invention, other embodiments may employ blinking lights, changing shapes and/or colors, text, as well as an auditory signal.

At block 90, the controller 16 may sample the settings retrieved at block 82 to determine if positional data regarding the apex locator 18 should be displayed. If so configured, then the controller 16 may receive and evaluate a signal from the apex locator module 18 beginning at block 92. The signal may convey dental data pertaining to a distance traveled by the apex locator probe relative to a fixed point within the patient's tooth. The signal as received at block 92 may be correlated to a table or otherwise processed at block 100 as necessary to generate a control signal.

In one instance, a suitable control signal may be formatted to initiate a display indicative of the locator distance at block 103. Where appropriate, the control signal may alternatively initiate a warning display at block 105. For instance, a digital readout may flash when the probe of the apex locator exceeds a preset, minimum distance from the apex. As such, the evaluation processes begun at block 100 may include an initial screening for the warning condition at block 101. The controller 16 may then transmit the control signal to the display at either block 102 or 105, as appropriate.

At block 103, the control signal may effectively activate cells of the display that are appropriate to communicate data conveyed in the signal from the apex locator module 18 at block 92. For instance, the control signal may initiate electron flow through an LCD 72 configured to present a numerical readout of the apex probe location. That is, a numerical readout may communicate the distance of the probe from the apex. As such, the observer may monitor the locator information as they simultaneously conduct the procedure. Where so desired at block 104, the dental data presented via the display at block 103 may be updated as subsequent signals arrive from the apex locator module 18. Significantly, the observer does not have to remove their eyes from the microscope to monitor the changing location of the probe. Thus, the flow of the procedure remains uninterrupted, contributing to greater efficiency and accuracy.

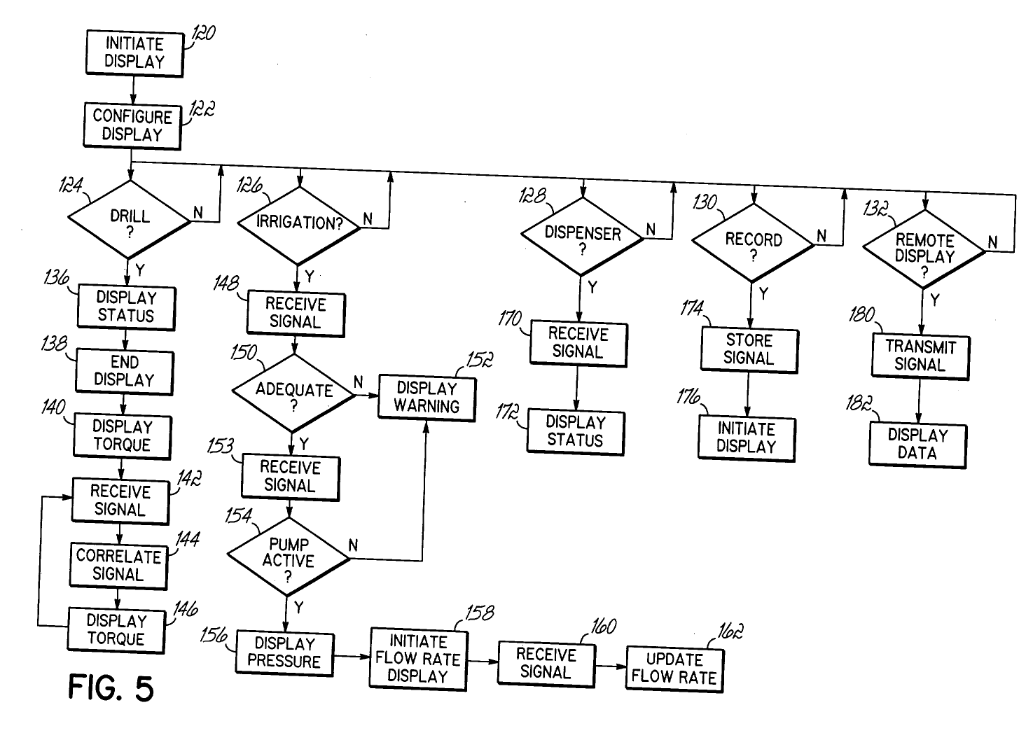

FIG. 5 is a flowchart having method steps that are also suitable for implementation within the hardware environments of FIGS. 1-3, and which highlight synergistic display features that are possible with embodiments of the present invention. At block 120, a controller 16 as described herein may cue the display of the system 10. That is, lights or other indicators of the display may activate to communicate the status of initialization processes to a user. The controller 16 may then prompt the user for display settings, while accessing any stored settings at block 122.

Exemplary settings may include the programmatic designation of what dental data the user wishes to overlay and/or border a magnified view of the object 52. For instance, the user may elect to have data pertaining to a drill 124, irrigation module 126 and filler dispenser 128 displayed within the same magnified image 50. In another embodiment, a display on a television screen that borders a projected image may convey the same data. Aspects of the selected and displayed data may communicate a comprehensive and synergistic perspective to the observer. Such perspective may translate into unique insights and increased awareness regarding a procedure. Thus, while the dental data 124-128 displayed in an image 50 may be separately viewed by an observer as desired, the unique display features of the present invention may allow a user to monitor different data points conjunctively.

Tracking a display sequence for one of the above dental parameters, the controller 16 may receive a status signal from a hand drill device 20 at block 136. The status signal may be transmitted to the controller 16 in response to a determination at block 124 that dental data relating to the hand drill device 20 is desired. The status signal sent from the hand drill 20 may communicate to the controller 16, for instance, whether the drill is powered. Accordingly, the controller 16 may initiate a display of such status information at block 136. In one embodiment, the display may be automatically terminated at block 138 by the controller 16 in response to the expiration of a preset increment of time. For instance, it may be desirable for the status display at block 86 to last for about two seconds. Such a configuration may be desirable where a user only wishes to be made initially aware of the drill's availability or power status.

Where so configured, the controller 16 may then automatically initiate display of drill torque at block 140. That is, the controller 16 may retrieve settings from within the system 10 that instruct the controller 16 to automatically display a torque parameter related from the hand drill 20. Thus, the user does not have to manually initialize the display. Initialization processes may precede reception of a signal from the hand drill device at block 142. The controller 16 may extract and correlate information conveyed within the signal at block 144 to produce a control signal formatted so as to affect the display at block 146. An exemplary torque display 64 is shown in FIG. 2.

Should the settings of block 122 indicate that irrigation information is additionally desired, then the controller 16 may receive a signal from the irrigation module at block 148. At block 150, the controller 16 may determine from the signal whether the water capacity in a reservoir of the irrigation module 24 exceeds some minimum, operational level. If not, then the controller 16 may initiate a display of a red warning light 54 at block 152. The warning light 54 may communicate to the user a potentially problematic scenario stemming from the detected shortage of fluid in the reservoir.

Should the binary evaluation conducted by the controller 16 at block 150 alternatively determine that the reservoir has an adequate amount of fluid, than the controller 16 may next receive signal 153 to determine whether dental data relating to a pump component of the irrigation module 24 is ready/powered at block 154. Should the pump be underpowered or have inadequate pressure as determined by the controller 16 at block 154, then the warning light 56 may activate at block 152. Alternatively, the display may present a pressure reading to the user in block 156 in response to the detection of adequate pressure levels. As such, the controller 16 may evaluate the status of the pump only after the reservoir status has first been established. Thus, a user may infer from the presentation of pump data that the status of the irrigation equipment is operational. In this manner, two parameters may combine within the display to form a single dental data point. As such, the display of one embodiment may account for a combination of dental data in an easily digestible format.

Where desired, the display of yet another dental parameter relating to the irrigation equipment may be automatically initiated at block 158. The controller 16 may initiate display of a flow rate associated with the irrigation module 24, which may be followed by reception of a signal from the irrigation module 24 at block 160. Of note, the same signal from the irrigation module 24 may convey all of the information evaluated at blocks 150, 154 and 158. The controller 16 may then update the flow rate display at block 162 prior to re-sequencing through the method steps at block 126. Thus, an embodiment of the present invention continuously monitors and updates dental data in a feedback loop.

The method steps of the flowchart of FIG. 5 may further accommodate displays of dental data relating to equipment configured to dispense filler material. The display of such data may be initiated at block 128. Such a display may involve receiving a signal from a filler dispenser 22 module at block 170. The controller 16 may then display a level or other indicator relating to the capacity of the filled dispenser 22 at block 72. As such, a user may simultaneously view multiple, related types of dental data in such a manner as the view of the object 52 remains unobstructed.

Where determined by the controller 16 at block 130 to be desired, an image 50 relating to any of the above discussed processes may be recorded at block 174. For instance, the controller 16 may initiate storage of video or still frames of an image 50 or sequence of images 50, to include applicable dental data 54-64 accompanying the procedure in time. The controller 16 may also initiate the display of an indicator light within the image 50 at block 176 when recording.

The observer at block 132 may configure the dental system 10 to display the image 50 as seen through the microscope eyepiece 14 at a remote monitor 32 or other presentation device. As such, a controller 16 may transmit a signal conveying an encoded view of the magnified object 52, along with the relevant dental data, to the remote monitor 32. At the monitor 32, the image 50 or sequences of images may be viewed by others watching the procedure.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. For instance, while the exemplary method step sequences shown in FIGS. 4 and 5 may have particular utility in certain contexts, it should be understood that the order and content of such steps may be rearranged, omitted, augmented and/or modified to suit different system requirements.

Moreover, one skilled in the art should recognize that other embodiments of the present invention may accommodate any number of display scenarios suited to application specifications and user preferences. Thus, the invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. An apparatus, comprising:
a display for presenting dental data within an observer's view of a magnified image of an oral cavity without substantially obstructing visual access to the magnified image, wherein the display is further configured to communicate the dental data to the observer; and
a controller in communication with the display and configured to receive a signal that conveys the dental data; the controller being further configured to adjust the display to communicate dental data to the observer.

2. The apparatus of claim 1, wherein the display and at least a portion of the magnified image are in overlapping relationship.

3. The apparatus of claim 1, wherein the display and magnified image are juxtaposed.

4. The apparatus of claim 1, wherein the dental data includes at least one parameter selected from the group consisting of: an instrument location, an instrument orientation, power status, magnification power, a reservoir capacity, a flow rate, a pressure reading, a temperature reading, a time reading, a patient condition and a display setting.

5. The apparatus of claim 1, wherein the dental data consists of equipment status.

6. The apparatus of claim 1, wherein transmission of the dental data to the controller is wireless.

7. The apparatus of claim 1, wherein the controller simultaneously receives dental data from a plurality of dental units.

8. The apparatus of claim 1, wherein the controller initiates disabling at least a portion of the display.

9. The apparatus of claim 1, wherein the controller generates the dental data by conjunctive processing multiple dental parameters.

10. The apparatus according to claim 1, wherein the controller initiates recording of the image.

11. The apparatus of claim 1, wherein the display includes a one presentation device selected from the group consisting of at least one of: a liquid crystal display, a television, a ray tube, a computer monitor, an eyepiece, eye wear, a light emitting diode and a laser projection device.

12. The apparatus of claim 1, wherein the display is configurable via voice recognition software.

13. The apparatus of claim 1, wherein the display is presented in at least one format selected from the group consisting of: text, a graph, a color scheme, a shape scheme and a light.

14. The apparatus of claim 1, wherein the display removably attaches to a microscope eyepiece.

15. The apparatus of claim 1, wherein the controller attaches to a microscope.

16. The apparatus of claim 1, wherein the display is substantially transparent.

17. The apparatus of claim 1, wherein the controller configures the display to substantially border the magnified image.

18. The apparatus of claim 1, wherein the controller is further configured to selectively initiate display of a data screen that interrupts visual access to the magnified image.

19. The apparatus of claim 1, wherein the controller initiates the display at an onset of an application in response to an initialization process.

20. The apparatus of claim 1, wherein the controller initiates the display in response to detection of a preset condition.

21. The apparatus of claim 1, further comprising a circuit for generating an audio signal.

22. A dental display system, comprising:
a dental unit configured to generate dental data;
a display for superimposing the dental data over an image without substantially obstructing visual access to the image, wherein the display is further configured to communicate the dental data to an observer; and
a controller in communication with the display and configured to receive a signal that conveys the dental data; the controller being further configured to adjust the display to communicate to the observer of the display the dental data.

23. An optical system configured to attach to an eyepiece of a microscope, comprising:
a display configured to present dental data within a magnified image of an oral cavity; and
a controller configured to receive a signal conveying the dental data and to instruct the display to communicate the dental data to an observer.

24. A method for communicating dental data to a user observing an image of an oral cavity as magnified by a microscope, comprising:
receiving at a controller a signal conveying dental data pertaining to a dental procedure;
transmitting a control signal from the controller to a display in communication with the controller, wherein the control signal is formatted to initiate presentation of the dental data within the display; and
within the display, presenting the dental data within view of the observer without substantially obstructing visual access to a magnified image.

25. The method of claim 24, wherein presenting the dental data further includes overlaying the dental data over the magnified image.

26. The method of claim 24, wherein presenting the dental data further includes juxtaposing the dental data next to the magnified image.

27. The method of claim 24, wherein presenting the dental data further comprises displaying the dental data consisting of equipment status.

28. The method of claim 24, wherein transmission of the control signal is wireless.

29. The method of claim 24, further comprising attaching the display to a microscope eyepiece.

30. The method of claim 24, wherein receiving the signal at the controller further comprises receiving the signal from a device configured to measure at least one parameter selected from the group consisting of: an instrument location, an instrument orientation, a power status, a magnification setting, a reservoir capacity, a flow rate, a pressure reading, a temperature reading, a time hack and a display setting.

31. The method of claim 24, further comprising initiating a switchable display of a data screen that obstructs visual access to the magnified image.

32. The method of claim 24, wherein presenting the dental data further includes initiating the display in response to a preset condition.
